(19) United States
(12) Patent Application Publication
(10) Pub. No.: US 2017/0269363 A1
(43) Pub. Date: Sep. 21, 2017

(54) PROJECTION-TYPE DISPLAY DEVICE, ELECTRONIC DEVICE, DRIVER VIEWING IMAGE SHARING METHOD, AND DRIVER VIEWING IMAGE SHARING PROGRAM

(71) Applicant: FUJIFILM Corporation, Tokyo (JP)

(72) Inventors: Koudai FUJITA, Saitama (JP); Daisuke ITO, Saitama (JP); Kenji ITO, Saitama (JP)

(73) Assignee: FUJIFILM Corporation, Tokyo (JP)

(21) Appl. No.: 15/613,271

(22) Filed: Jun. 5, 2017

Related U.S. Application Data
(63) Continuation of application No. PCT/JP2015/081632, filed on Nov. 10, 2015.

(30) Foreign Application Priority Data
Dec. 22, 2014 (JP) 2014-258977

(51) Int. Cl. G02B 27/01; H04N 5/225; G02B 27/18; B60K 37/04; B60R 11/02

(52) U.S. Cl. CPC G02B 27/0101; B60K 37/04; B60R 11/02; G02B 27/18; H04N 5/225; G02B 2027/0163; B60K 2350/2052; B60K 35/00

(57) ABSTRACT

Provided are a projection-type display device, an electronic device, a driver viewing image sharing method, and a non-transitory computer readable recording medium storing a driver viewing image sharing program. An HUD comprises a captured image data acquisition unit that acquires captured image data from an imaging unit that captures ahead of a windshield, a projection image data generation unit that analyzes the acquired captured image data and generates projection image data, a projection unit that modulates light emitted from a light source unit according to the projection image data and projects the modulated light onto a combiner, a driver viewing image data generation unit that generates driver viewing image data in which the projection image data is overlapped on the captured image data, and a communication unit that transmits the driver viewing image data to an electronic device that includes a display unit and exists in the motor vehicle.

### CROSS-REFERENCE TO RELATED APPLICATIONS

This application is a Continuation of PCT International Application No. PCT/JP2015/081632 filed on Nov. 10, 2015, which claims priority under 35 U.S.C. §119(a) to Japanese Patent Application No. 2014-258977 filed on Dec. 22, 2014. Each of the above application(s) is hereby expressly incorporated by reference, in its entirety, into the present application.

### BACKGROUND OF THE INVENTION

1. Field of the Invention

The present invention relates to a projection-type display device, an electronic device, a driver viewing image sharing method, and a non-transitory computer readable recording medium storing a driver viewing image sharing program.

2. Description of the Related Art

A head-up-display (HUD) device for a motor vehicle that uses a windshield of the motor vehicle or a combiner provided in front of the windshield as a screen and projects projection light thereto to display an image is known (for example, see JP2013-154712A). According to such an HUD, a user can visually recognize an image displayed on the windshield or the like by the projection light projected from the HUD with the image being overlapped with a scene in front of a host vehicle beyond the windshield or the like.

JP2013-154712A discloses a motor vehicle that includes an HUD serving as a display for a driver and a display for a fellow passenger. In this motor vehicle, by setting the amounts of information to be displayed to be different between the HUD and the display for the fellow passenger, it is possible to provide appropriate information to each person who is in the motor vehicle.

JP2003-287708A discloses a system that does not relate to an HUD, which transfers a video image that a wearer of a head-mounted display is watching to an external device which is connected in a wireless manner to the head-mounted display so that a person other than the wearer can confirm the video image.

### SUMMARY OF THE INVENTION

An HUD mounted on a motor vehicle is designed so that an image (warning information or the like for notifying a dangerous object ahead) projected onto a windshield can be most easily viewed by a driver, and it is difficult for a fellow passenger who sits on an assistant seat to clearly confirm the image. If information about a warning can be confirmed by a fellow passenger, it is possible to enhance safety, but such a product has not been provided up to now.

In order to show a projected image to a fellow passenger, a method of providing two HUDs in a motor vehicle may be considered. However, it is difficult to provide two HUDs in a defined space. Further, the manufacturing cost of the motor vehicle increases.

In the system disclosed in JP2013-154712A, only content received from an external center is displayed on a display for a fellow passenger, and the fellow passenger cannot share an image that a driver is watching.

Since the system disclosed in JP2003-287708A does not relate to a system using an HUD, problems in a case where the HUD is mounted on a motor vehicle are not considered.

In consideration of the above-mentioned problems, an object of the invention is to provide a projection-type display device, an electronic device, a driver viewing image sharing method, and a non-transitory computer readable recording medium storing a driver viewing image sharing program capable of causing a scene in a field of vision of a driver of a motor vehicle to be easily shared by a fellow passenger.

According to an aspect of the invention, there is provided a projection-type display device mounted on a motor vehicle, including: a captured image data acquisition unit that acquires captured image data from an imaging unit that is mounted on the motor vehicle and performs imaging in a traveling direction of the motor vehicle; a projection image data generation unit that analyzes the captured image data acquired by the captured image data acquisition unit, extracts an obstacle or a dangerous object, and generates projection image data indicating the obstacle or the dangerous object; a projection unit that modulates light emitted from a light source unit in accordance with the projection image data and projects the modulated light onto a projection surface; a driver viewing image data generation unit that generates driver viewing image data in which the projection image data is overlapped on the captured image data; a transmission unit that transmits the driver viewing image data to an electronic device that includes a display unit that displays an image based on image data and exists in the motor vehicle; and an electronic device detection unit that automatically allows the projection-type display device to communicate with the electronic device in a case where it is determined that the electronic device exists in the motor vehicle on the basis of a position information of the electronic device.

According to another aspect of the invention, there is provided an electronic device including: a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and extracts an obstacle or a dangerous object and generates projection image data, indicating the obstacle or the dangerous object, a light source unit, a projection unit that modulates light emitted from the light source unit in accordance with the projection image data and projects the modulated light onto a projection surface that exists in the motor vehicle, a driver viewing image data generation unit that generates driver viewing image data in which the projection image data is overlapped on the captured image data, and an electronic device detection unit that automatically allows the projection-type display device to communicate with the electronic device in a case where it is determined that the electronic device exists in the motor vehicle on the basis of a position information of the electronic device; an acquisition unit that acquires the driver viewing image data from the projection-type display device through the communication unit; a display unit that displays an image based on image data; and a display control unit that causes the display unit to display an image based on the driver viewing image data.

According to still another aspect of the invention, there is provided a driver viewing image sharing method including: a captured image data acquisition step of acquiring captured image data from an imaging unit that is mounted on a motor vehicle and performing imaging in a traveling direction of the motor vehicle; a projection image data generation step of analyzing the captured image data acquired in the captured image data acquisition step, extracting an obstacle or a dangerous object, and generating projection image data indicating the obstacle or the dangerous object; a projection step of modulating light emitted from a light source unit in accordance with the projection image data and projecting the modulated light onto a projection surface that exists in the motor vehicle; a driver viewing image data generation step of generating driver viewing image data in which the projection image data is overlapped on the captured image data; a transmission step of transmitting the driver viewing image data to an electronic device that includes a display unit that displays an image based on image data and exists in the motor vehicle; and an electronic device detection step of automatically allowing the projection-type display device to communicate with the electronic device in a case where it is determined that the electronic device exists in the motor vehicle on the basis of a position information of the electronic device.

According to still another aspect of the invention, there is provided a driver viewing image sharing method including: a step of acquiring, through a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and extracts an obstacle or a dangerous object and generates projection image data indicating the obstacle or the dangerous object, a light source unit, a projection unit that modulates light emitted from the light source unit in accordance with the projection image data and projects the modulated light onto a projection surface that exists in the motor vehicle, a driver viewing image data generation unit that generates driver viewing image data in which the projection image data is overlapped on the captured image data, and an electronic device detection unit that automatically allows the projection-type display device to communicate with the electronic device in a case where it is determined that the electronic device exists in the motor vehicle on the basis of a position information of the electronic device, the driver viewing image data from the projection-type display device; and a step of displaying an image based on the driver viewing image data on a display unit.

According to still another aspect of the invention, there is provided a non-transitory computer readable recording medium storing a driver viewing image sharing program for causing a computer to execute: a captured image data acquisition step of acquiring captured image data from an imaging unit that is mounted on a motor vehicle and performing imaging in a traveling direction of the motor vehicle; a projection image data generation step of analyzing the captured image data acquired in the captured image data acquisition step, extracting an obstacle or a dangerous object, and generating projection image data indicating the obstacle or the dangerous object; a projection step of modulating light emitted from a light source unit in accordance with the projection image data and projecting the modulated light onto a projection surface that exists in the motor vehicle; a driver viewing image data generation step of generating driver viewing image data in which the projection image data is overlapped on the captured image data; a transmission step of transmitting the driver viewing image data to an electronic device that includes a display unit that displays an image based on image data and exists in the motor vehicle; and an electronic device detection step of automatically allowing the projection-type display device to communicate with the electronic device in a case where it is determined that the electronic device exists in the motor vehicle on the basis of a position information of the electronic device.

According to still another aspect of the invention, there is provided a non-transitory computer readable recording medium storing a driver viewing image sharing program for causing a computer to execute: a step of acquiring, through a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and extracts an obstacle or a dangerous object and generates projection image data indicating the obstacle or the dangerous object, a light source unit, a projection unit that modulates light emitted from the light source unit in accordance with the projection image data and projects the modulated light onto a projection surface that exists in the motor vehicle, a driver viewing image data generation unit that generates driver viewing image data in which the projection image data is overlapped on the captured image data, and an electronic device detection unit that automatically allows the projection-type display device to communicate with the electronic device in a case where it is determined that the electronic device exists in the motor vehicle on the basis of a position information of the electronic device, the driver viewing image data from the projection-type display device; and a display control step of causing a display unit to display an image based on the driver viewing image data.

According to the invention, it is possible to provide a projection-type display device, a driver viewing image sharing method, and a non-transitory computer readable recording medium storing a driver viewing image sharing program capable of causing a scene in a field of vision of a driver of a motor vehicle to be easily shared by a fellow passenger.

### BRIEF DESCRIPTION OF THE DRAWINGS

FIG. 1 is a diagram showing a configuration of an HUD which is an embodiment of a projection-type display device of the invention.

FIG. 2 is a diagram showing a configuration example of a display unit 4 shown in FIG. 1.

FIG. 3 is a diagram showing functional blocks of a system control unit 48 in the display unit 4 and blocks showing an internal configuration of an electronic device 9.

FIG. 4 is a flowchart illustrating operations of the HUD and the electronic device 9 shown in FIG. 1.

FIG. 5 is a diagram used for illustrating the operations of FIG. 4.

FIG. 6 is a diagram used for illustrating the operations of FIG. 4.

FIG. 7 is a flowchart illustrating a first modified example of the operations of the HUD and the electronic device 9 shown in FIG. 1.

FIG. 8 is a diagram used for illustrating the operations of FIG. 7.

FIG. 9 is a flowchart illustrating a second modified example of the operations of the HUD and the electronic device 9 shown in FIG. 1.

FIG. 10 is a diagram used for illustrating the operations of FIG. 9.

FIG. 11 is a diagram used for illustrating the operations of FIG. 9.

### DESCRIPTION OF THE PREFERRED EMBODIMENTS

Hereinafter, embodiments of the invention will be described with reference to the accompanying drawings.

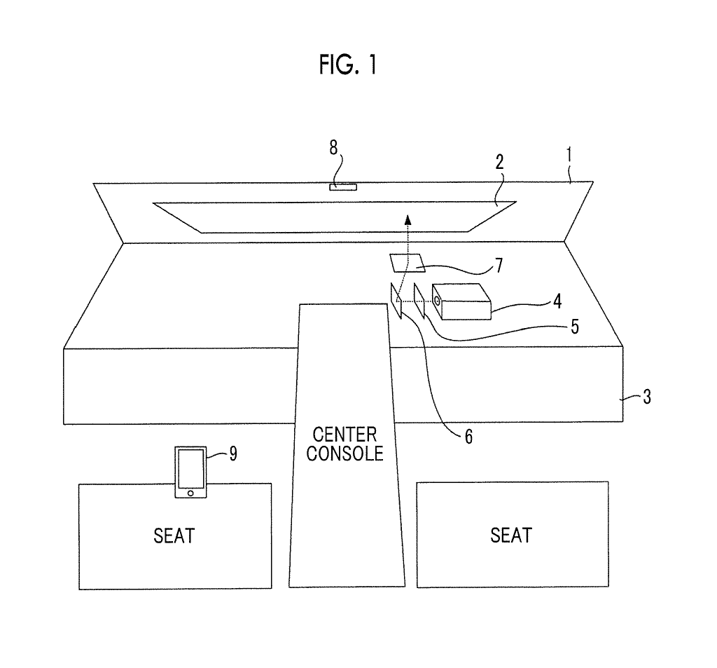

FIG. 1 is a diagram showing a configuration of an HUD which is an embodiment of a projection-type display device of the invention. The HUD is mounted on a motor vehicle for use.

The HUD shown in FIG. 1 includes a display unit 4 which is provided in a dashboard 3 of a motor vehicle, a projection unit including a diffuser panel 5, a reflecting mirror 6, and a magnifier 7, and a combiner 2 attached to an inner surface of a windshield 1 of the motor vehicle.

The diffuser panel 5 diffuses light corresponding to projection image data emitted from the display unit 4 to change this light to a surface light source.

The reflecting mirror 6 reflects the light diffused in the diffuser panel 5 to the magnifier 7 side.

The magnifier 7 magnifies an image based on the light reflected by the reflecting mirror 6, and projects the magnified image onto the combiner 2.

The combiner 2 is a projection surface that exists in the motor vehicle, onto which the light projected from the magnifier 7 is projected, and reflects the light. A driver of the motor vehicle can view the light reflected by the combiner 2 to visually recognize information or the like relating to driving. Further, the combiner 2 has a function of reflecting the light projected from the magnifier 7, and at the same time, transmitting light from the outside (outside world) of the windshield 1. Thus, the driver can visually recognize the image based on the light projected from the magnifier 7 and a scene of the outside world of the windshield 1 in an overlapping manner.

An imaging unit 8 that images a scene ahead of the windshield 1 in a traveling direction of the motor vehicle is provided on an upper part of the windshield 1. The imaging unit 8 and the display unit 4 are connected to each other in a wired or wireless manner, and captured image data obtained through imaging of the imaging unit 8 is output to the display unit 4. The imaging unit 8 may be dedicated for the HUD, or may be an imaging unit mounted on a motor vehicle for a different purpose such as a collision prevention system.

An electronic device 9 which is possessed by a fellow passenger exists in the motor vehicle. The electronic device 9 is a portable computer in which a central processing unit (CPU), a read only memory (ROM), a random access memory (RAM), an operation unit, a display unit, and the like are provided, for example. The electronic device is, for example, a smartphone, a mobile phone with a camera, a tablet terminal (personal digital assistant), and the like.

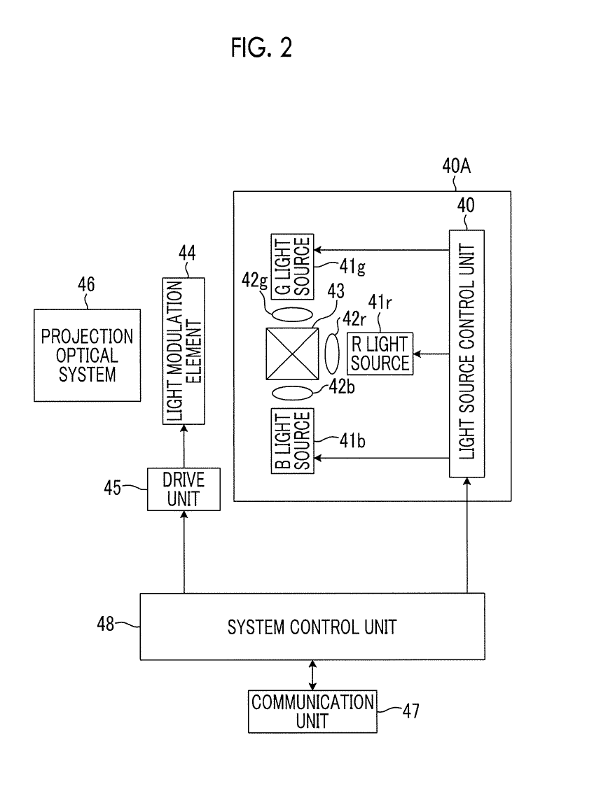

FIG. 2 is a diagram showing a configuration example of the display unit 4 shown in FIG. 1.

The display unit 4 includes a light source unit 40A, a light modulation element 44, a drive unit 45 that drives the light modulating element 44, a projection optical system 46, a communication unit 47, and a system control unit 48 that generally controls the entire components.

The light source unit 40A includes a light source control unit 40, an R light source 41r which is a red light source that emits red light, a G light source 41g which is a green light source that emits green light, a B light source 41b which is a blue light source that emits blue light, a dichroic prism 43, a collimator lens 42r provided between the R light source 41r and the dichroic prism 43, a collimator lens 42g provided between the G light source 41g and the dichroic prism 43, and a collimator lens 42b provided between the B light source 41b and the dichroic prism 43.

The dichroic prism 43 is an optical member for guiding light emitted from each of the R light source 41r, the G light source 41g, and the B light source 41b to the same optical path. As the optical element having such a function is not limited to the dichroic prism. For example, a cross dichroic mirror may be used.

The dichroic prism 43 transmits R light collimated by the collimator lens 42r, and emits the R light to the light modulating element 44. Further, the dichroic prism 43 reflects G light collimated by the collimator lens 42g, and emits the G light to the light modulating element 44. The dichroic prism 43 reflects B light collimated by the collimator lens 42b, and emits the B light to the light modulating element 44.

As the R light source 41r, the G light source 41g, and the B light source 41b, a light emitting element such as a laser or a light-emitting diode (LED) may be used, respectively. In the present embodiment, an example in which the HUD includes three light sources of the R light source 41r, the G light source 41g, and the B light source 41b is shown, but the number of light sources may be two, or four or more.

The light source control unit 40 sets the amount of light emission of each of the R light source 41r, the G light source 41g, and the B light source 41b to a predetermined light emission amount pattern, and performs a control for sequentially emitting light from the R light source 41r, the G light source 41g, and the B light source 41b in accordance with the light emission amount patterns.

The light modulating element 44 modulates light emitted from the dichroic prism 43, and emits light corresponding to projection image data (red image light, blue image light, and green image light) to the projection optical system 46.

As the light modulating element 44, for example, liquid crystal on silicon (LCOS), a digital mirror device (DMD), micro electro mechanical systems (MEMS) element, a liquid crystal display device, or the like may be used.

The drive unit 45 drives the light modulating element 44 according to projection image data input from the system control unit 48, and causes the light modulating element 44 to emit light (red image light, blue image light, and blue image light) corresponding to the projection image data to the projection optical system 46.

The projection optical system 46 is an optical system for projecting light emitted from the light modulating element 44 to the diffuser panel 5. The light modulating element 44, the projection optical system 46, the diffuser panel 5, the reflecting mirror 6, and the magnifier 7 form a projection unit that modulates light emitted from the light source unit 40A according to projection image data and projects the modulated light to the combiner 2 which is a projection surface.

The communication unit 47 is an interface for performing near field wireless communication with the electronic device 9 that exists in the motor vehicle. A communication interface based on, for example, Bluetooth (registered trademark) is used as the interface. Of course, other communication interfaces may be used.

The system control unit 48 controls the light source control unit 40 and the drive unit 45.

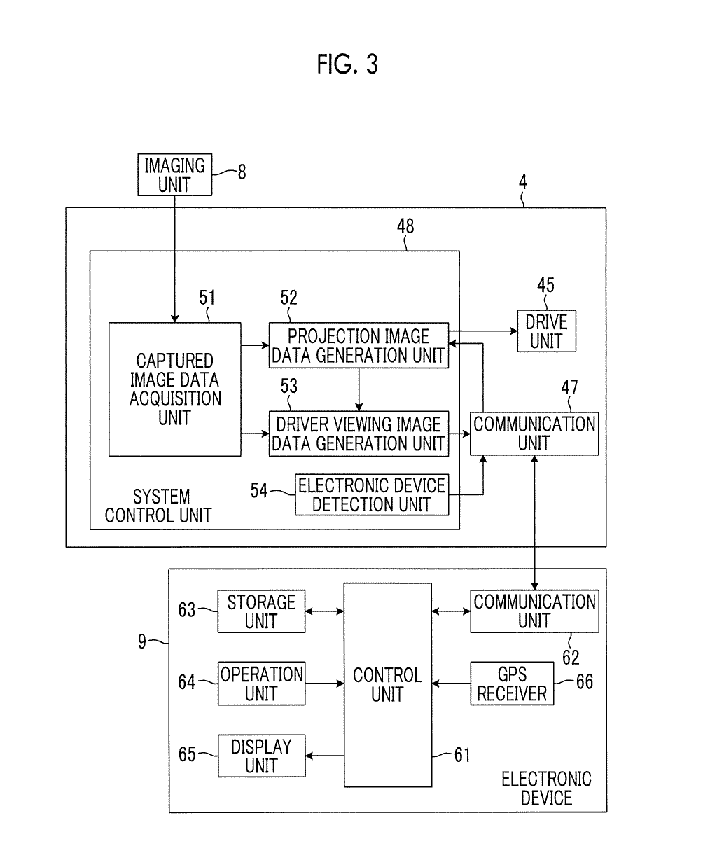

FIG. 3 is a diagram showing functional blocks of the system control unit 48 of the display unit 4 and blocks showing an internal configuration of the electronic device 9.

As shown in FIG. 3, the system control unit 48 includes a captured image data acquisition unit 51, a projection image data generation unit 52, a driver viewing image data generation unit 53, and an electronic device detection unit 54.

The captured image data acquisition unit 51 acquires captured image data obtained through imaging of the imaging unit 8 from the imaging unit 8, and outputs the captured image data to the projection image data generation unit 52 and the driver viewing image data generation unit 53.

The projection image data generation unit 52 analyzes the captured image data acquired by the captured image data acquisition unit 51 by a known image analysis process to generate projection image data. The projection image data generation unit 52 outputs the generated projection image data to the drive unit 45 and the driver viewing image data generation unit 53.

Specifically, the projection image data generation unit 52 detects an obstacle or a dangerous object such as a pedestrian, a telegraph pole, a street tree, or an accident vehicle from the captured image data. In a case where the obstacle or the dangerous object is detected, the projection image data generation unit 52 generates projection image data for notifying the detected obstacle or dangerous object.

The captured image data corresponds to a scene ahead of the windshield 1. Further, a relation indicating that an image is projected onto a certain region of the captured image data (the scene ahead of the windshield 1) when certain pixels of the light modulating element 44 are effective (the “effective” means a state where pixels reflect or transmit light to be output to the projection optical system 46) is determined in advance. Thus, if a region of the obstacle or the dangerous object detected from the captured image data can be known, it is also possible to determine which projection image data is to be output to the drive unit 45.

The projection image data generation unit 52 also generates projection image data indicating a traveling speed of a motor vehicle and guide information for performing a navigation to a destination.

The driver viewing image data generation unit 53 generates driver viewing image data in which the projection image data generated by the projection image data generation unit 52 is overlapped on the captured image data acquired by the captured image data acquisition unit 51, and transmits the generated driver viewing image data to the electronic device 9 that exists in the motor vehicle through the communication unit 47. The communication unit 47 functions as a transmission unit that transmits the driver viewing image data to the electronic device 9 that exists in the motor vehicle.

The electronic device detection unit 54 detects an electronic device 9 that exists in the motor vehicle. For example, the electronic device detection unit 54 compares position information of the motor vehicle received by a global positioning system (GPS) receiver for a navigation system mounted on the motor vehicle with position information received by a GPS receiver 66 (which will be described later) mounted on the electronic device 9. The electronic device detection unit 54 acquires the position information of the electronic device 9 through the communication unit 47.

If there is no large difference between two pieces of position information, the electronic device detection unit 54 determines that the electronic device 9 during communication exists in the motor vehicle. If there is a large difference between two pieces of position information, the electronic device detection unit 54 determines that the electronic device 9 during communication exists outside the motor vehicle. In a case where it is determined that the electronic device 9 exists in the motor vehicle, the electronic device detection unit 54 allows the communication unit 47 to perform data transmission and reception with the electronic device 9. Thus, a state where data transmission and reception is possible between the electronic device 9 that exist in the motor vehicle and the HUD is obtained.

The electronic device 9 includes a control unit 61, a communication unit 62, a storage unit 63 including a storage medium such as a flash memory or a read only memory (ROM), an operation unit 64 for inputting a variety of information, a display unit 65 that displays an image based on image data, and the GPS receiver 66.

The control unit 61 includes a processor that executes a program stored in the ROM of the storage unit 63, as a main component. The control unit 61 acquires driver viewing image data received by the communication unit 62, and causes the display unit 65 to display an image based on the acquired driver viewing image data. The control unit 61 functions as an acquisition unit and a display control unit.

The communication unit 62 is a communication interface for performing near field wireless communication with another electronic device including the HUD shown in FIG. 1.

The storage unit 63 stores data received through the communication unit 62, or stores data necessary for an operation of the electronic device 9.

The operation unit 64 is an interface for inputting a variety of instructions to the control unit 61, and is configured by a variety of buttons, or a touch panel mounted on the display unit 65, for example.

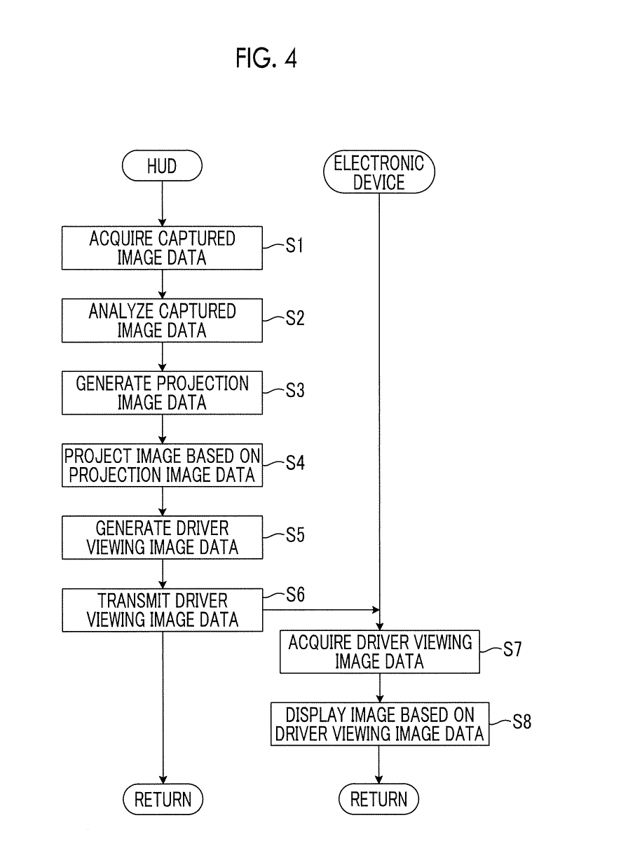

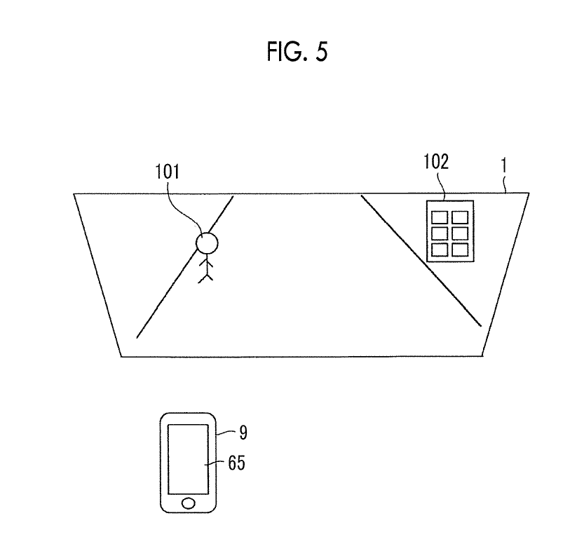

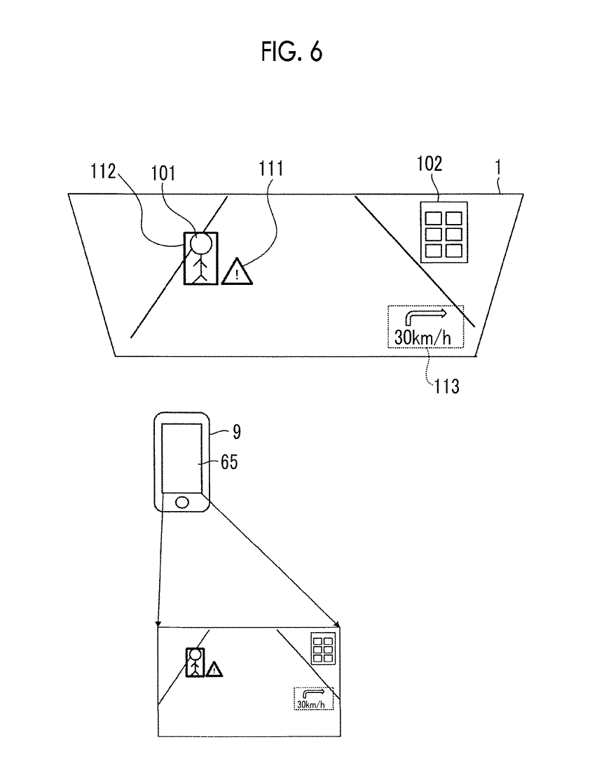

FIG. 4 is a flowchart for illustrating operations of the HUD and the electronic device 9 shown in FIG. 1. In description of FIG. 4, specific processing content will be described with reference to display examples of FIGS. 5 and 6.

FIG. 5 is a diagram showing a scene that a driver is watching in a state where an HUD is not started up. In the example of FIG. 5, a pedestrian 101 and a building 102 are visibly recognized through the windshield 1 of the motor vehicle during traveling.

In a state where the HUD is started up, a fellow passenger gets in the motor vehicle with the electronic device 9. Thus, negotiation is performed between the communication unit 47 of the display unit 4 and the communication unit 62 of the electronic device 9, and the existence of the electronic device 9 is detected by the electronic device detection unit 54. Thus, data transmission and reception is possible between the communication unit 47 of the HUD and the communication unit 62 of the electronic device 9.

If the HUD is started up, the captured image data acquisition unit 51 acquires captured image data obtained by imaging of the imaging unit 8 (step S1).

Then, the projection image data generation unit 52 analyzes the captured image data acquired by the captured image data acquisition unit 51 (step S2), and generates projection image data on the basis of the analysis result (step S3).

In the example of FIG. 5, the pedestrian 101 is interpreted as an obstacle or a dangerous object, and projection image data for notifying the existence of the obstacle or the dangerous object and an existence position thereof is generated. Further, the projection image data generation unit 52 generates projection image data for displaying a traveling speed of the motor vehicle and navigation information.

The projection image data generation unit 52 inputs the projection image data generated in step S3 to the drive unit 45. The drive unit 45 drives the light modulating element 44 according to the projection image data input from the projection image data generation unit 52, and perform modulation of light emitted from the light source unit 40A. An image based on the projection image data is projected onto the combiner 2 through the above-described modulation (step S4).

Images 111 to 113 based on the projection image data are projected onto the combiner 2 by the process of step S4, as shown in FIG. 6. The image 111 is a warning mark for notifying the existence of an obstacle or a dangerous object. The image 112 is a frame image indicating a region recognized as an obstacle or a dangerous object. The image 113 is an image indicating a traveling speed of the motor vehicle and navigation information. A driver easily detects the pedestrian 101 by visually recognizing the image 111 and the image 112 projected onto the combiner 2 and an outside scene in an overlapping manner.

Then, the driver viewing image data generation unit 53 generates driver viewing image data in which the projection image data generated in step S3 is overlapped on the captured image data acquired by the captured image data acquisition unit 51 (step S5). The driver viewing image data generation unit 53 transmits the driver viewing image data generated in step S5 to the electronic device 9 that exists in the motor vehicle through the communication unit 47 (step S6).

The control unit 61 of the electronic device 9 acquires the driver viewing image data transmitted from the HUD through the communication unit 62 (step S7). Further, the control unit 61 causes the display unit 65 to display an image based on the acquired driver viewing image data (step S8).

Thus, as shown in FIG. 6, an image in which virtual images (the images 111, 112, and 113) are overlapped on a subject image captured by the imaging unit 8 is displayed on the display unit 65 of the electronic device 9. That is, an image corresponding to a scene that a driver is watching is displayed on the display unit 65 of the electronic device 9 in real time.

In this way, a driver can visibly recognize the images 111 and 112 projected onto the combiner 2 and an outside scene ahead of the windshield 1 in an overlapping manner, and thus, can easily detect a dangerous situation of the pedestrian 101 or the like. A projection unit of the HUD is designed so that a driver can most easily recognize the images 111 and 112 projected onto the combiner 2. Thus, the images 111 and 112 are not easily viewed by a person other than the driver. However, according to the HUD shown in FIG. 1, a fellow passenger can also confirm a scene that a driver is watching in real time by the display unit 65 of the electronic device 9. Thus, for example, even in a case where the driver is not aware of a pedestrian 101, it can be expected that the fellow passenger can be aware of the pedestrian 101 and can take action such as calling attention to the driver, for example.

Further, in the HUD shown in FIG. 1, a case where due to malfunction of the R light source 41r, the G light source 41g, or B light source 41b, or the light modulating element 44, the image 111 or the image 112 is not displayed on the combiner 2 may be considered, for example. In such a situation, it is difficult for a driver to perceive a dangerous situation of the pedestrian 101 or the like.

According to the HUD shown in FIG. 1, even in a case where malfunction occurs in the R light source 41r, the G light source 41g, or the B light source 41b, or the light modulating element 44, since an image based on projection image data is necessarily displayed on the display unit 65, a fellow passenger can perceive a dangerous situation, to thereby secure safety. In addition, since a driver and a fellow passenger shares visible information, it is possible to recognize a situation that is visible to the fellow passenger but is not visible to the driver, and thus, the driver and the fellow passenger can perceive malfunction of the HUD.

The HUD shown in FIG. 1 is a system that shows an image corresponding to a scene that a driver is watching to a fellow passenger using the electronic device 9 possessed by the fellow passenger. Thus, it is not necessary to provide a dedicated display device in a motor vehicle, and thus, to achieve cost reduction.

By installing an application program for information sharing with a driver in the electronic device 9 and starting up the application program by a fellow passenger, the above-described processes may be performed. In this case, when starting up the application program, the control unit 61 of the electronic device 9 may execute pairing with the HUD, and may notify the electronic device detection unit 54 of the HUD that the electronic device 9 exists in the motor vehicle.

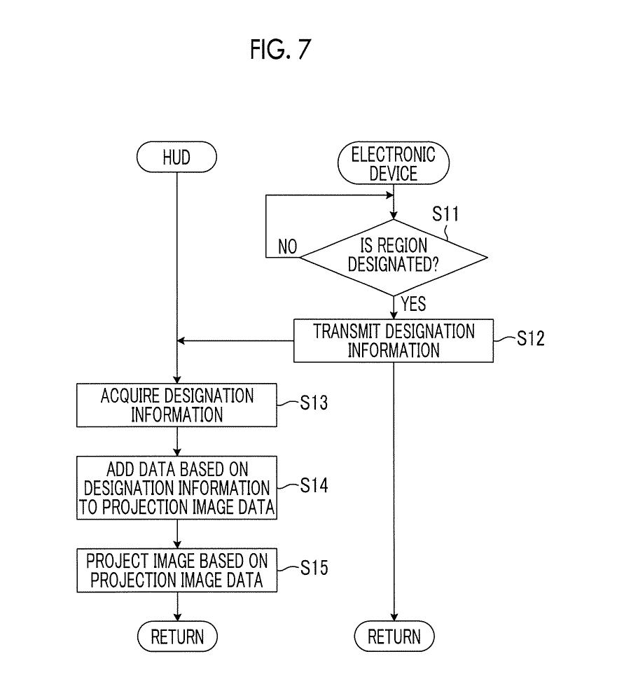

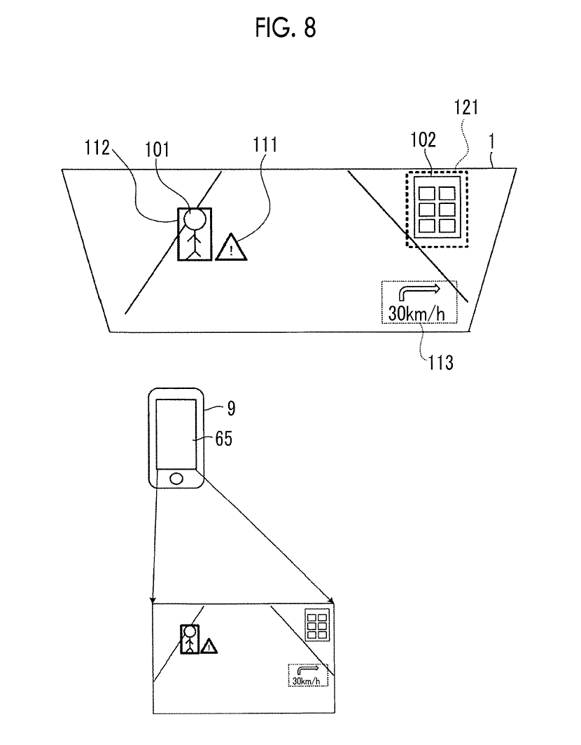

FIG. 7 is a flowchart illustrating a first modified example of the operations of the HUD and the electronic device 9 shown in FIG. 1. In description of FIG. 7, specific processing content will be described with reference to a display example of FIG. 8.

The control unit 61 of the electronic device 9 determines whether a specific region is designated with respect to an image displayed on the display unit 65 (step S11).

In a case where a destination to which a fellow passenger wants to go is displayed in an image based on driver viewing image data displayed on the display unit 65 of the electronic device 9, the fellow passenger designates a region in the vicinity of the destination (for example, a building 102 in FIG. 8) on the image to notify a driver of the destination.

Thus, the control unit 61 of the electronic device 9 determines that the specific region is designated from the image based on the driver viewing image data (YES in step S11), and transmits designation information indicating the specific region to the communication unit 47 of the HUD through the communication unit 62 (step S12). The control unit 61 of the electronic device 9 functions as a first transmission unit.

The designation information is information indicating coordinates of the specific region in the driver viewing image data during being displayed on the display unit 65. Coordinates of each pixel in the driver viewing image data correspond to coordinates of each pixel in captured image data.

The projection image data generation unit 52 of the HUD acquires designation information transmitted from the electronic device 9 and received through the communication unit 47 (step S13). Further, the projection image data generation unit 52 adds data for emphasizing a region based on the designation information in the captured image data to the projection image data generated by analyzing the captured image data (step S14).

The captured image data corresponds to a scene ahead of the windshield 1. Further, a relation indicating that an image is projected onto a certain region of the captured image data (the scene ahead of the windshield 1) when certain pixels of the light modulating element 44 are effective (the “effective” means a state where pixels reflect or transmit light to be output to the projection optical system 46) is determined in advance. Thus, if there exists designation information, it is possible to generate data for projecting an image into a region of captured image data designated by the designation information.

Then, the projection image data generation unit 52 inputs the projection image data generated in step S14 to the drive unit 45. Thus, the image based on the projection image data to which the data is added is projected onto the combiner 2 (step S15).

Through the process of step S15, an image 121 based on the projection image data is additionally projected with respect to the example of FIG. 6, for example, as shown in FIG. 8. The image 121 is a frame image indicating a region corresponding to a specific region designated from an image which is being displayed on the display unit 65 by a user of the electronic device 9. The image 121 is only an example, and any image capable of notifying a driver that the building 102 is designated may be used.

As described above, in a case where a destination to which a fellow passenger wants to go is displayed in an image displayed on the display unit 65 of the electronic device 9, the fellow passenger can designate the destination, to thereby emphasize and display the destination on the combiner 2. A driver can recognize the image 121 indicating a specific region together with an outside scene, and can easily recognize the destination of the fellow passenger. This configuration is effective in a case where a passenger of a taxi notifies a driver of the taxi of a destination, for example.

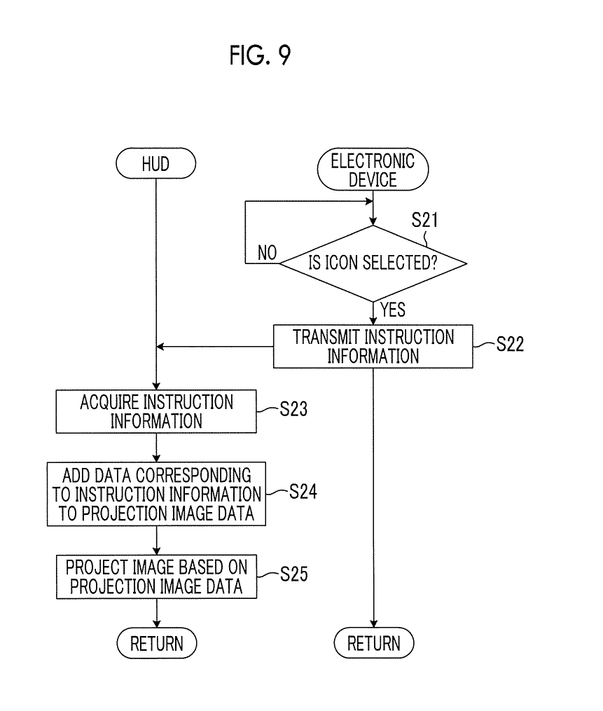

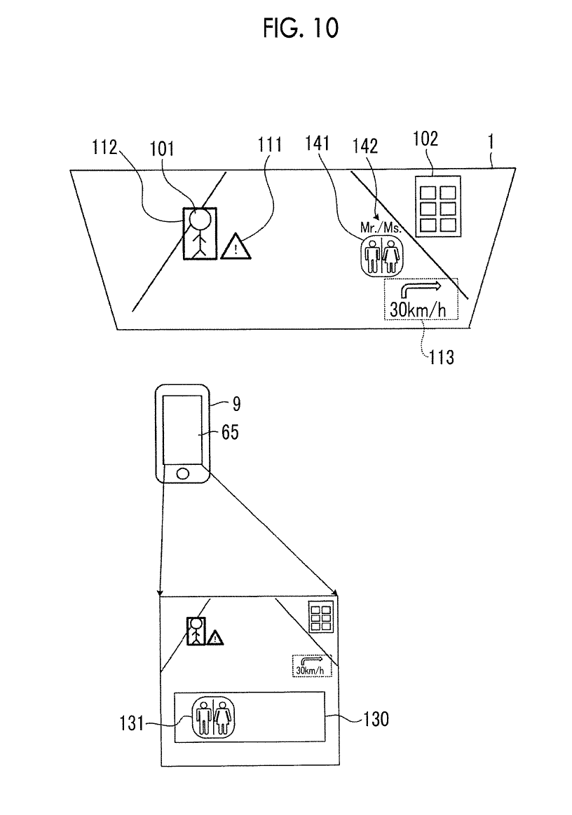

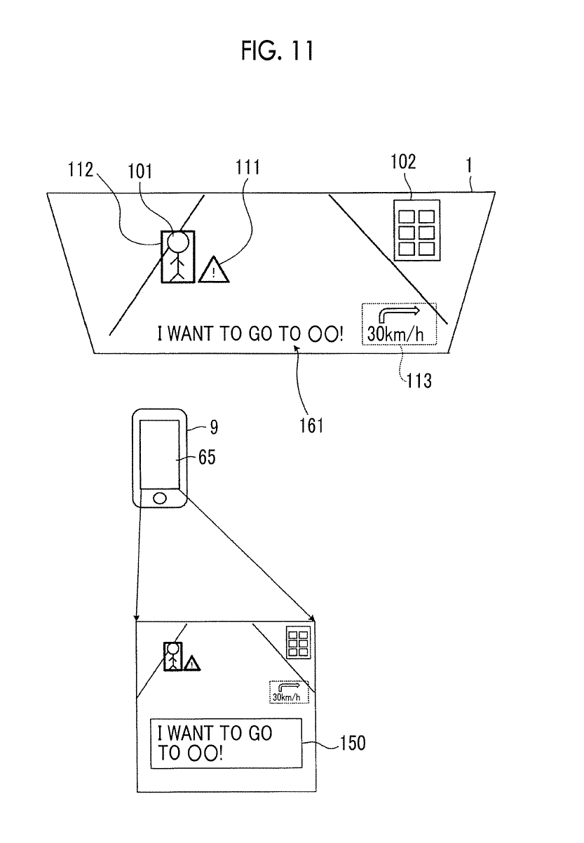

FIG. 9 is a flowchart illustrating a second modified example of the operations of the HUD and the electronic device 9 shown in FIG. 1. In description of FIG. 9, specific processing content will be described with reference to display examples of FIGS. 10 and 11.

If the operation unit 64 is operated and a menu display instruction is made, the control unit 61 of the electronic device 9 causes the display unit 65 to display a menu 130 as shown in FIG. 10. A plurality of icons may be displayed in the menu 130, but in the example of FIG. 10, a restroom icon 131 is displayed.

The control unit 61 of the electronic device 9 determines which one of the icons included in the menu 130 displayed on the display unit 65 is to be selected (step S21).

If the restroom icon 131 included in the menu 130 is selected by a fellow passenger, the control unit 61 transmits instruction information for instructing addition of an image to be projected onto the combiner 2 to the communication unit 47 of the HUD through the communication unit 62 (step S22). The instruction information is different for each selected icon, and image data corresponding to the instruction information is stored in a memory (not shown) of the HUD. The control unit 61 of the electronic device 9 functions as a second transmission unit.

The projection image data generation unit 52 of the HUD acquires the instruction information received by the communication unit 47 (step S23). Further, the projection image data generation unit 52 adds data (image data stored in the memory corresponding to the instruction information) for projecting an image based on the acquired instruction information to projection image data generated by analyzing captured image data (step S24).

Then, the projection image data generation unit 52 inputs the projection image data generated in step S24 to the drive unit 45. Thus, the projection image data generation unit 52 projects an image based on the projection image data to which the image data is added onto the combiner 2 (step S25).

For example, as shown in FIG. 10, an image 141 (in the figure, a restroom mark) is additionally projected onto the combiner 2 with respect to the example of FIG. 6. A driver can recognize that the fellow passenger wants to go to a restroom by the image 141 projected onto the combiner 2.

The control unit 61 may transmit arbitrary text information input from a user of the electronic device 9 to the HUD together with the instruction information. Further, the projection image data generation unit 52 of the HUD adds data corresponding to the instruction information and image data for displaying the text information simultaneously transmitted with the instruction information to projection image data generated by analyzing imaging data. In the example of FIG. 10, a text image 142 called “Mr. or Ms. A” is displayed together with the image 141. Thus, the driver can easily know who wants to go to the restroom.

A configuration corresponding to text input will be described. In this configuration, the control unit 61 of the electronic device 9 causes the display unit 65 to display a character input box 150, as shown in FIG. 11. If a message to be additionally projected onto the combiner 2 is input to the character input box 150, the control unit 61 transmits instruction information for instructing addition of the message to the HUD.

If the instruction information is acquired, the projection image data generation unit 52 generates projection image data to which data for displaying an image (message) based on the instruction information is added. Thus, as shown in FIG. 11, a text image 161 is additionally projected.

As described above, during traveling of the motor vehicle, a fellow passenger can express his or her intention to a driver. For example, there may be a case in which it is difficult for a fellow passenger who is in a final seat in a motor vehicle having three row seats to talk with a driver. For this reason, the configuration shown in FIG. 11 becomes effective. Further, the configuration is also effective for a person with a handicap in conversation.

A program for causing a computer to execute the respective processes to be performed by the system control unit 48 and the control unit 61 of this embodiment may be provided. Such a program may be recorded on a computer-readable non-transitory recording medium.

Such a “computer-readable recording medium” includes, for example, an optical medium such as a compact disc(CD)-ROM, a magnetic recording medium such as a memory card, or the like. Further, such a program may be provided by being downloaded through a network.

As described above, the present specification discloses the following content.

A disclosed projection-type display device is a projection-display device which is mounted on a motor vehicle, and includes a captured image data acquisition unit that acquires captured image data from an imaging unit that is mounted on the motor vehicle and performs imaging in a traveling direction of the motor vehicle, a projection image data generation unit that analyzes the captured image data acquired by the captured image data acquisition unit and generates projection image data, a projection unit that modulates light emitted from a light source unit in accordance with the projection image data and projects the modulated light onto a projection surface, a driver viewing image data generation unit that generates driver viewing image data in which the projection image data is overlapped on the captured image data, and a transmission unit that transmits the driver viewing image data to an electronic device that includes a display unit that displays an image based on image data and exists in the motor vehicle.

In the disclosed projection-type display device, the projection image data generation unit acquires designation information indicating a specific region designated from an image based on the driver viewing image data displayed on the display unit from the electronic device, and adds data for emphasizing a region based on the designation information in the captured image data to the projection image data.

In the projection-type display device, the projection image data generation unit acquires instruction information for instructing addition of an image to be projected onto the projection surface from the electronic device, and adds data for projecting an image based on the instruction information to the projection image data.

A disclosed electronic device includes a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and generates projection image data, a projection unit that modulates light emitted from a light source unit in accordance with the projection image data and projects the modulated light onto a projection surface that exists in the motor vehicle, and a driver viewing image data generation unit that generates driver viewing image data in which the projection image data is overlapped on the captured image data; an acquisition unit that acquires the driver viewing image data from the projection-type display device through the communication unit; a display unit that displays an image based on image data; and a display control unit that causes the display unit to display an image based on the driver viewing image data.

The disclosed electronic device further includes a first transmission unit that transmits designation information indicating a specific region designated from the image based on the driver viewing image data displayed on the display unit to the projection-type display device through the communication unit.

The disclosed electronic device further includes a second transmission unit that transmits instruction information for instructing addition of an image to be projected onto the projection surface to the projection-type display device through the communication unit.

A disclosed a driver viewing image sharing method includes a captured image data acquisition step of acquiring captured image data from an imaging unit that is mounted on a motor vehicle and performing imaging in a traveling direction of the motor vehicle, a projection image data generation step of analyzing the captured image data acquired in the captured image data acquisition step and generating projection image data, a projection step of modulating light emitted from a light source unit in accordance with the projection image data and projecting the modulated light onto a projection surface that exists in the motor vehicle, a driver viewing image data generation step of generating driver viewing image data in which the projection image data is overlapped on the captured image data, and a transmission step of transmitting the driver viewing image data to an electronic device that includes a display unit that displays an image based on image data and exists in the motor vehicle.

The disclosed driver viewing image sharing method further includes a step of acquiring designation information indicating a specific region designated from an image based on the driver viewing image data displayed on the display unit of the electronic device from the electronic device. In the projection image data generation step, data for emphasizing a region based on the designation info' illation in the captured image data is added to the projection image data.

The disclosed driver viewing image sharing method further includes a step of acquiring instruction information for instructing addition of an image to be projected onto the projection surface from the electronic device. In the projection image data generation step, data for projecting an image based on the instruction information is added to the projection image data.

A disclosed driver viewing image sharing method includes: a step of acquiring, through a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and generates projection image data, a light source unit, a projection unit that modulates light emitted from the light source unit in accordance with the projection image data and projects the modulated light onto a projection surface that exists in the motor vehicle, and a driver viewing image data generation unit that generates driver viewing image data in which the projection image data is overlapped on the captured image data, the driver viewing image data from the projection-type display device, and a step of displaying an image based on the driver viewing image data on a display unit.

The driver viewing image sharing method further includes a step of transmitting designation information indicating a specific region designated from the image based on the driver viewing image data displayed on the display unit to the projection-type display device through the communication unit.

The disclosed driver viewing image sharing method further includes a step of transmitting instruction information for instructing addition of an image to be projected onto the projection surface to the projection-type display device through the communication unit according to an operation of an operation unit.

A disclosed driver viewing image sharing program for causing a computer to execute: a captured image data acquisition step of acquiring captured image data from an imaging unit that is mounted on a motor vehicle and performing imaging in a traveling direction of the motor vehicle; a projection image data generation step of analyzing the captured image data acquired in the captured image data acquisition step and generating projection image data; a projection step of modulating light emitted from a light source unit in accordance with the projection image data and projecting the modulated light onto a projection surface that exists in the motor vehicle; a driver viewing image data generation step of generating driver viewing image data in which the projection image data is overlapped on the captured image data; and a transmission step of transmitting the driver viewing image data to an electronic device that includes a display unit that displays an image based on image data and exists in the motor vehicle.

A disclosed driver viewing image sharing program for causing a computer to execute: a step of acquiring, through a communication unit that performs communication with a projection-type display device that includes a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and generates projection image data, a light source unit, a projection unit that modulates light emitted from the light source unit in accordance with the projection image data and projects the modulated light onto a projection surface that exists in the motor vehicle, and a driver viewing image data generation unit that generates driver viewing image data in which the projection image data is overlapped on the captured image data, the driver viewing image data from the projection-type display device; and a display control step of causing a display unit to display an image based on the driver viewing image data.

### INDUSTRIAL APPLICABILITY

The invention is effective and provides high convenience, particularly, in application to an HUD for a motor vehicle.

### EXPLANATION OF REFERENCES

8: imaging unit

9: electronic device

44: light modulating element

45: drive unit

47: communication unit

51: captured image data acquisition unit

52: projection image data generation unit

53: driver viewing image data generation unit

61: control unit

62: communication unit

65: display unit

What is claimed is:

1. A projection-type display device mounted on a motor vehicle, comprising:
a captured image data acquisition unit that acquires captured image data from an imaging unit that is mounted on the motor vehicle and performs imaging in a traveling direction of the motor vehicle;
a projection image data generation unit that analyzes the captured image data acquired by the captured image data acquisition unit, extracts an obstacle or a dangerous object, and generates projection image data indicating the obstacle or the dangerous object;
a projection unit that modulates light emitted from a light source unit in accordance with the projection image data and projects the modulated light onto a projection surface;
a driver viewing image data generation unit that generates driver viewing image data in which the projection image data is overlapped on the captured image data;
a transmission unit that transmits the driver viewing image data to an electronic device that has a display unit that displays an image based on image data and exists in the motor vehicle; and
an electronic device detection unit that automatically allows the projection-type display device to communicate with the electronic device in a case where it is determined that the electronic device exists in the motor vehicle on the basis of a position information of the electronic device.

2. The projection-type display device according to claim 1,
wherein the projection image data generation unit acquires designation information indicating a specific region designated from an image based on the driver viewing image data displayed on the display unit from the electronic device, and adds data for emphasizing a region based on the designation information in the captured image data to the projection image data.

3. The projection-type display device according to claim 1,
wherein the projection image data generation unit acquires instruction information for instructing addition of an image to be projected onto the projection surface from the electronic device, and adds data for projecting an image based on the instruction information to the projection image data.

4. The projection-type display device according to claim 2,
wherein the projection image data generation unit acquires instruction information for instructing addition of an image to be projected onto the projection surface from the electronic device, and adds data for projecting an image based on the instruction information to the projection image data.

5. An electronic device comprising:
a communication unit that performs communication with a projection-type display device that has a captured image data acquisition unit that acquires captured image data from an imaging unit that is mounted on a motor vehicle and performs imaging in a traveling direction of the motor vehicle, a projection image data generation unit that analyzes the captured image data acquired by the captured image data acquisition unit and extracts an obstacle or a dangerous object and generates projection image data indicating the obstacle or the dangerous object, a light source unit, a projection unit that modulates light emitted from the light source unit in accordance with the projection image data and projects the modulated light onto a projection surface that exists in the motor vehicle, a driver viewing image data generation unit that generates driver viewing image data in which the projection image data is overlapped on the captured image data, and an electronic device detection unit that automatically allows the projection-type display device to communicate with the electronic device in a case where it is determined that the electronic device exists in the motor vehicle on the basis of a position information of the electronic device;
an acquisition unit that acquires the driver viewing image data from the projection-type display device through the communication unit;
a display unit that displays an image based on image data; and
a display control unit that causes the display unit to display an image based on the driver viewing image data.

6. The electronic device according to claim 5, further comprising:
a first transmission unit that transmits designation information indicating a specific region designated from the image based on the driver viewing image data displayed on the display unit to the projection-type display device through the communication unit.

7. The electronic device according to claim 6, further comprising:
a second transmission unit that transmits instruction information for instructing addition of an image to be projected onto the projection surface to the projection-type display device through the communication unit.

8. A driver viewing image sharing method using the projection-type display device according to claim 1, comprising:
a captured image data acquisition step of acquiring the captured image data from the imaging unit that is mounted on a motor vehicle and performing imaging in a traveling direction of the motor vehicle;
a projection image data generation step of analyzing the captured image data acquired in the captured image data acquisition step, extracting the obstacle or the dangerous object, and generating the projection image data indicating the obstacle or the dangerous object;
a projection step of modulating light emitted from the light source unit in accordance with the projection image data and projecting the modulated light onto the projection surface that exists in the motor vehicle;
a driver viewing image data generation step of generating the driver viewing image data in which the projection image data is overlapped on the captured image data;
a transmission step of transmitting the driver viewing image data to the electronic device that has the display unit that displays an image based on the image data and exists in the motor vehicle; and
an electronic device detection step of automatically allowing the projection-type display device to communicate with the electronic device in a case where it is determined that the electronic device exists in the motor vehicle on the basis of a position information of the electronic device.

9. The driver viewing image sharing method according to claim 8, further comprising:
a step of acquiring designation information indicating a specific region designated from an image based on the driver viewing image data displayed on the display unit of the electronic device from the electronic device,
wherein in the projection image data generation step, data for emphasizing a region based on the designation information in the captured image data is added to the projection image data.

10. The driver viewing image sharing method according to claim 8, further comprising:
a step of acquiring instruction information for instructing addition of an image to be projected onto the projection surface from the electronic device,
wherein in the projection image data generation step, data for projecting an image based on the instruction information is added to the projection image data.

11. The driver viewing image sharing method according to claim 9, further comprising:
a step of acquiring instruction information for instructing addition of an image to be projected onto the projection surface from the electronic device,
wherein in the projection image data generation step, data for projecting an image based on the instruction information is added to the projection image data.

12. A driver viewing image sharing method using the electronic device according to claim 5, comprising:
a step of acquiring, through the communication unit that performs communication with the projection-type display device that has the captured image data acquisition unit that acquires captured the image data from the imaging unit that is mounted on the motor vehicle and performs imaging in a traveling direction of the motor vehicle, the projection image data generation unit that analyzes the captured image data acquired by the captured image data acquisition unit and extracts the obstacle or the dangerous object and generates the projection image data indicating the obstacle or the dangerous object, the light source unit, the projection unit that modulates light emitted from the light source unit in accordance with the projection image data and projects the modulated light onto the projection surface that exists in the motor vehicle, the driver viewing image data generation unit that generates the driver viewing image data in which the projection image data is overlapped on the captured image data, and the electronic device detection unit that automatically allows the projection-type display device to communicate with the electronic device in a case where it is determined that the electronic device exists in the motor vehicle on the basis of a position information of the electronic device, the driver viewing image data from the projection-type display device; and
a step of displaying an image based on the driver viewing image data on the display unit.

13. The driver viewing image sharing method according to claim 12, further comprising:
a step of transmitting designation information indicating a specific region designated from the image based on the driver viewing image data displayed on the display unit to the projection-type display device through the communication unit.

14. The driver viewing image sharing method according to claim 13, further comprising:
a step of transmitting instruction information for instructing addition of an image to be projected onto the projection surface to the projection-type display device through the communication unit according to an operation of an operation unit.

15. A non-transitory computer readable recording medium storing a driver viewing image sharing program for causing a computer to execute and to function as the projection-type display device according to claim 1:
a captured image data acquisition step of acquiring the captured image data from the imaging unit that is mounted on the motor vehicle and performing imaging in a traveling direction of the motor vehicle;
a projection image data generation step of analyzing the captured image data acquired in the captured image data acquisition step, extracting the obstacle or the dangerous object, and generating the projection image data indicating the obstacle or the dangerous object;
a projection step of modulating light emitted from the light source unit in accordance with the projection image data and projecting the modulated light onto the projection surface that exists in the motor vehicle;
a driver viewing image data generation step of generating the driver viewing image data in which the projection image data is overlapped on the captured image data;
a transmission step of transmitting the driver viewing image data to the electronic device that has the display unit that displays an image based on the image data and exists in the motor vehicle; and
an electronic device detection step of automatically allowing the projection-type display device to communicate with the electronic device in a case where it is determined that the electronic device exists in the motor vehicle on the basis of a position information of the electronic device.

16. A non-transitory computer readable recording medium storing a driver viewing image sharing program for causing a computer to execute and to function as the electronic device according to claim 5:
a step of acquiring, through the communication unit that performs communication with the projection-type display device that has the captured image data acquisition unit that acquires captured the image data from the imaging unit that is mounted on the motor vehicle and performs imaging in a traveling direction of the motor vehicle, the projection image data generation unit that analyzes the captured image data acquired by the captured image data acquisition unit and extracts the obstacle or the dangerous object and generates the projection image data indicating the obstacle or the dangerous object, the light source unit, the projection unit that modulates light emitted from the light source unit in accordance with the projection image data and projects the modulated light onto the projection surface that exists in the motor vehicle, the driver viewing image data generation unit that generates the driver viewing image data in which the projection image data is overlapped on the captured image data, and the electronic device detection unit that automatically allows the projection-type display device to communicate with the electronic device in a case where it is determined that the electronic device exists in the motor vehicle on the basis of a position information of the electronic device, the driver viewing image data from the projection-type display device; and
a display control step of causing the display unit to display an image based on the driver viewing image data.
